(19) United States
(12) Patent Application Publication
(10) Pub. No.: US 2003/0195676 A1
(43) Pub. Date: Oct. 16, 2003

(54) Fuel and vehicle monitoring system and method

(76) Inventors: Andrew Jeffrey Kelly, Arlington, TX (US); Steven Kenneth Bradford, Edmond, OK (US)

Correspondence Address: Lynn E. Barber, Post Office Box 16528, Fort Worth, TX, 76162, US

(21) Appl. No.: 10/122,519

(22) Filed: Apr. 15, 2002

(51) Int. Cl. G06F 19/00

(52) U.S. Cl. 701/29; 701/123; 340/438

(57) ABSTRACT

A fuel and vehicle monitoring system for use with one or more vehicles of a business, which includes a computer system; a system for monitoring vehicle location and distance traveled by the vehicle; a system for monitoring fuel usage of the vehicle; a system for entering user information into the computer; and a system for downloading information from the computer to a remote business site.

### BACKGROUND OF THE INVENTION

1. Field of the Invention

This invention relates to systems used to monitor vehicle fuel usage and dispensing, and other vehicle-related parameters.

2. Description of the Related Art

There are a number of different systems that have been developed to try to address the needs of current business practices by reducing the dependence upon vehicle operators in maintaining an accurate accounting of the fuel used and general well-being of the vehicle. These systems include computer-controlled systems, keyed systems, magnetic cards, and radio frequency identification tags.

Many of these systems are dependent upon changing the infrastructure of fuel delivery. The use of additional equipment such as detection sensors and additional computers in a participating refueling station is addressed by several inventions. The further addition of computer systems at these stations is needed to complete the transaction. For example, U.S. Pat. No. 5,923,572 addresses fuel dispensing and authorizing. This system requires a radio frequency control to be mounted on both the vehicle and on the fuel dispensing station. A radio frequency tag is present on the vehicle and is sensed by sensors acting as antennae. A computer installed at the site reads the data presented, determines if the vehicle identity is correct, and logs the usage and amount of fuel. This system requires that participating stations have installed the sensors and computers with the appropriate software. Shortcomings of this system include that it also does not address problems of the theft of fuel by overfilling, does not provide a means of evaluation of the performance of the vehicle, and does not keep the operator from making errors in judgment in operation and recording.

U.S. Pat. Nos. 5,938,716 and 5,847,644 each disclose an onboard computer system that optimizes vehicle and engine performance. U.S. Pat. No. 5,847,644 attempts to integrate all vehicle systems, such as the engine, fuel, cooling, braking and vehicle diagnostics, into one computer system. U.S. Pat. No. 5,938,716 uses an additional computer to work in conjunction with the engine computer. Data can be input by use of a magnetic card. These patents do not address problems associated with common business practices, such as comparing the amount of fuel used by the vehicle to the amount of fuel purchased for the vehicle, providing detailed driving patterns of the operator to minimize excessive vehicle use, providing an operator-friendly interface between the computer and the operator, such as a keypad and screen, providing a link between computers via cellular communication, and providing a system that utilizes current gasoline credit card systems as well as state of the art communication systems.

Several devices such as onboard computers and vehicle security devices have been used in the past. Thus, U.S. Pat. No. 5,794,164 addresses navigation, security and vehicle diagnostics. This patent improves upon prior commercial devices by combining several independent systems under one main system. The patent does not address fuel consumption and refueling of the work vehicle.

U.S. Pat. No. 5,550,738 discloses a means of monitoring a vehicle's movements such as the distance traveled and the time spent in operation of the vehicle. A computer monitors the use of the vehicle by measuring the shaft rotation versus time and provides a general picture of the distance and velocity the vehicle traveled as well as the time spent with no movement or with the engine idle. This limits the commercial usage of this system to long haul trucking because vehicles still use fuel while the engine is running. When the transmission is in neutral, the shaft is stationary which is where this device obtains its data. In long haul trucking, the vehicle is moving essentially 100% of the total time that the engine is on. In contrast, most commercial service vehicle are moving a much lower percentage of the time that the engine is on. This is due to city conditions and site conditions. Consequently fuel usage varies significantly in most commercial usage. Commercial businesses need a method of telling where a vehicle is, how far it has traveled, what route it has taken, and how much fuel the vehicle has used, as well as a method of controlling the amount of fuel dispensed to the vehicle with as much accuracy as possible.

Security is also a concern of business owners. U.S. Pat. No. 5,620,446 discloses a method of preventing a vehicle from unauthorized usage by using an input device such as a coded, simple keyed input method. This invention interacts with the antilock braking system (ABS), which is present on most of today's vehicles, and therefore is not easily retrofitted to existing vehicles.

While these prior systems advance the state of the art, they are separate systems that address a portion of the problems associated with running a business, with each system employing a separate method of data input and extraction and not interfacing with other systems. Together they also do not address the final problem of monitoring fuel usage and dispensing of fuel without complex solutions that require that additional equipment installed in fuel stations.

It is therefore an object of the invention, in addition to providing the advantages of many of the patents described, to provide a method and system for monitoring the fuel consumption of a vehicle with an acceptable measure of accuracy. It is a further object of the invention to provide a portable accounting method and system for tracking expenditures, a method and system capable of maintaining contact with a vehicle, a method and system capable of communicating remotely with a base unit, such as the customer's home computer or any office computer, and a vehicle tracking system. The invention herein enables a reduction in the costs associated with maintaining a business.

Other objects and advantages will be more fully apparent from the following disclosure and appended claims.

### SUMMARY OF THE INVENTION

The invention herein is a fuel and vehicle monitoring method and system comprising a computer, a sensor to monitor distance traveled, a sensor to monitor fuel usage, a magnetic card encoder, an interface to a digital telephone, and an interface to a Global Positioning System (GPS). The invention records, maintains and authorizes the amounts of fuel used by a vehicle and authorizes refueling only in the amount downloaded onto a magnetic card from the main processing unit.

Other objects and features of the inventions will be more fully apparent from the following disclosure and appended claims.

### BRIEF DESCRIPTION OF THE DRAWINGS

FIG. 1 is a schematic diagram of a vehicle with the computer and sensors of the invention installed.

FIG. 2 is a general schematic showing the various main connections of the system of the invention.

FIG. 3 shows an exterior view of the computer screen, card reader and other components of the invention.

FIG. 4 shows the installation of the flow monitor used in the invention.

FIG. 5 shows a detailed schematic diagram of the connected components of the invention.

FIG. 6 is a flow chart of steps that may be used in the invention.

### DETAILED DESCRIPTION OF THE INVENTION AND PREFERRED EMBODIMENTS THEREOF

In general, the invention herein provides a fuel and vehicle monitoring system for use by a business, comprising

a) a computer;

b) a vehicle fuel flow sensor;

c) a system for monitoring vehicle location and distance traveled by the vehicle;

d) a system for entering user information into the computer; and

e) a system for downloading information from the computer to a remote business site.

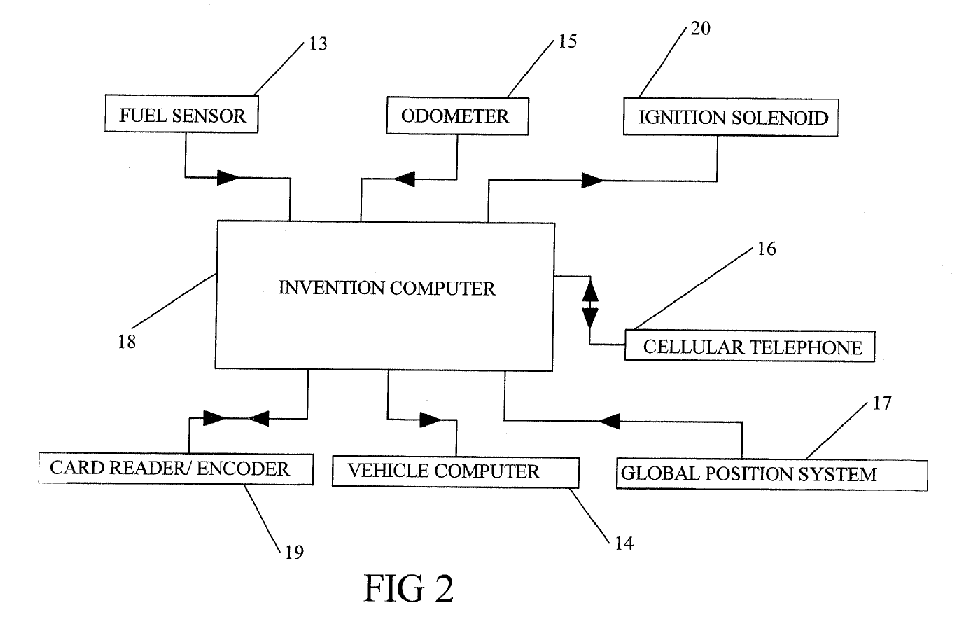

The present invention provides a fuel and vehicle monitoring system, which requires minimum input from the operator (user of the vehicle). In its preferred embodiment, each of the following components is mounted on or installed in the vehicle: 1) an independent (stand alone) computer comprising a central processing unit; 2) a sensor for monitoring fuel consumption, 3) a system to access the vehicle odometer, 4) an interface to a Global Positioning System (GPS), which together with the odometer access allows monitoring of the vehicle location and distance traveled; 5) an interface connection to a read/write credit/debit card encoder/reader, and 6) an interface to a digital telephone. The main connections of this system are shown in FIG. 2. The operator only has to use a magnetic card configured as a credit card or debit card. The computer handles the recording of data. Data is transferred via the phone or card. Each of these components is discussed generally below, followed by a detailed discussion of the invention as shown in the figures.

Central Processing Unit

The central processing unit (main computer or CPU, which is generally the business's computer server) is preferably an Embedded WINDOWS™ CE Single Board computer that utilizes Microsoft WINDOWS™-CE software. The current preferred embodiment utilizes model CE-SBC-SC400 single board computer (R.L.C. Enterprises Inc., Paso Robles, Calif.) herein referred to as the main invention computer or the CPU. Incorporated into the CPU are a touch screen, Windows-CE operation system, color LCD display, I/O ports and communication ports as are standard parts of this computer unit. In particular, this computer has 32-bit AMD ELAN SC400 (100-Mhz. 486 CPU) Built-In FLASH programmer/Loader/Bios, 12-Mega-Bytes onboard FLASH, 16-Mega-Bytes onboard DRAM, and 8 Mega-Bytes onboard FLASH Disk.

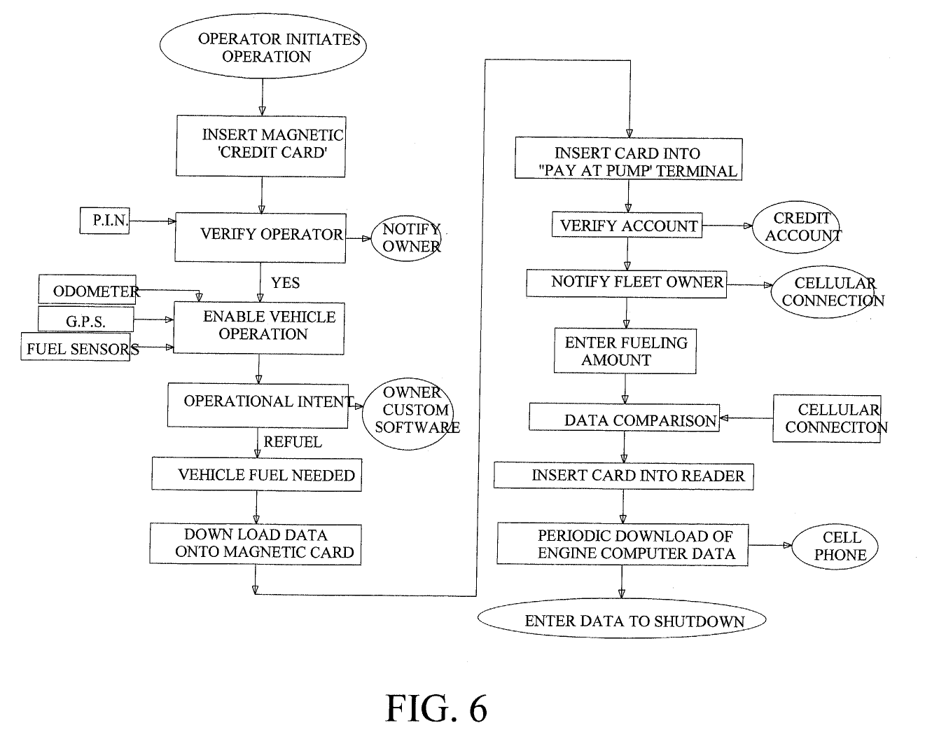

The control program of the invention is preferably written with embedded Visual C++ or embedded Visual Basic of Microsoft Corporation, each of which is readily recognized by WINDOWS™ CE and easily obtained. Other languages can be used but are likely to be more difficult to use or not have software readily available. This software presents a visual image as well as providing a method to control data. The invention software program is written using standard means known in the art to interface with the operator, the vehicle, the card reader, the cellular phone and the GPS. The touch screen is programmed to be both an input and an output device. The software enables the screen to be configured as both a computer keyboard and an output screen, using known programming methods. A flow chart of steps that may be used in the invention is provided in FIG. 6, the components of which are discussed later herein.

The computer obtains data from different sources on the vehicle, which may include any sensor that the vehicle may have that produces either a digital or analog signal that is accessible by the invention; however, only sensors pertaining to distance and fuel usage are particularly important to the invention in its preferred embodiments as described herein. The fuel flow sensor from which data is obtained in the invention can be either part of the original equipment of the vehicle or can be retrofitted. Information pertaining to the distance traveled is obtained from the odometer of the vehicle. The direction of travel and the vehicle location are obtained from the GPS (see below).

The computer uses the inputs from the sensors to calculate distance traveled, velocity profile, fuel consumption and location coordinates. Information obtained from reading the vehicle odometer or using the GPS system and distance readings are stored in the computer. A signal from the fuel sensor is sent to the computer for collection and storage of data, including the amount of fuel used and the rate of fuel used per distance traveled. A consumption profile is stored in the computer memory for later downloading by the appropriate device.

A connection to the vehicle's onboard computer system or engine computer is used to help diagnose engine problems and works in connection with this computer. The standard connection to obtain information from the vehicle conforms to SAE J1850, which is a standardized communication protocol (Society of Automotive Engineers standard for automobiles). Connection to this data bus enables the invention computer to read data that is available from the vehicle engine computer, such as distance traveled. This invention can be utilized to provide a remote connection from the vehicle and the home office, enabling the owner to determine the maintenance schedule of his fleet, the extent of this information being dependant on how much information is available from the particular vehicle's computer. Information from the engine computer is transmitted via cable connection to the main computer of the invention. This information is held until the operator downloads this information either through a memory device or a digital cell phone interface.

Fuel Sensor

The fuel sensor in the preferred embodiment of the invention is an oscillating piston positive displacement fuel flow meter with a range of 0.25 to 50 gallons per hour, such as an ABB Model 8 with Reed Switch Pulser (ABB Water Meters, Inc., Ocala, Fla.). Output from the flow meter is a two-wire DC electric output. The signal produced is sent to the main computer via this cable in the form of pulses that transmit data. The computer counts these pulses and sums the amount of pulses. The number of pulses is directly equal to a measured amount of fuel. This measured amount as recorded by the computer is the amount of fuel that the vehicle has used. The accuracy of the meter is within one percent throughout the entire flow range. Fuel consumption is obtained by reading the fuel sensor, which is placed directly in the fuel line between the vehicle storage line and the engine. A signal from this sensor is sent to the main computer for collection of data. The amount of fuel used is stored as well as the amount of fuel used per distance traveled. A consumption profile is stored in the computer for later downloading by an appropriate device, such as a company's main computer, using, for example, either a cell phone or a communication direct link via electronic cable or by a memory card (credit card).

Vehicle Odometer

The computer obtains mileage data from different sources on the vehicle. The mileage is obtained from the internal data set supplied from the electronic data on the vehicle or by a magnetic sensor in the transmission or by accessing data from the GPS. The vehicle mileage most preferably is obtained by accessing the trip odometer, if the vehicle is older, or by accessing the vehicle's communication bus if it is newer. This bus originates at the engine control unit (ECU) and goes to the dashboard. This bus utilizes SAE J1850, discussed above, which enables all the different electronic modules to communicate with each other. The invention utilizes the data that is available in the ECU by monitoring the information that is sent out from the unit several times a second. This packet of information contains a header and the data. The header identifies the packet as a distance reading and the data as a number corresponding to the distance traveled.

When an older vehicle is fitted with the invention that utilizes an analog system mileage data can be obtained by mounting a magnetic pulse sensor onto the output gearing of the transmission. A typical sensor would be similar to Turck Model Bi 1-EG05-AN6X (Turck, Inc., Plymouth, Minn.). The sensor sends an electrical pulse to the computer each time a gear tooth passes. Each pulse correlates to a measured distance the vehicle has traveled. The sum of the pulses maintained in the invention computer directly correlates to distance traveled. Two sets of data, one of which is from the GPS (see further discussion below), are calculated and compared to verify mileage moved by the vehicle. Data is obtained from the GPS once per second giving an average distance traveled of 40 feet between samples at a speed of 70 mph.

Global Positioning System

A global position system (GPS) is added to provide a detailed location map versus time. This provides the vehicle owner the ability to monitor the vehicle location and the amount of time spent in traveling or when the vehicle is parked. This information is stored in the computer for later downloading to an appropriate device, such as the cell phone. Inclusion of the global positioning system verifies the accuracy of the odometer reading and verifies that the user has not departed significantly from the planned work path. A preferred GPS receiver is a Motorola GT PLUS ONCORE™. This system communicates via communication ports, supplying latitude, longitude, altitude, velocity, heading and time through the COM ports provided on the computer.

Card Encoder

A card reader/encoder is attached to the computer allowing information to be entered and disseminated. The card reader/encoder, for example, a MCE Magnetic Card Encoder (B & Data Systems, Shady Cove, Oreg.), utilizes ISO/ANSI data formats. Input and Output data to the invention computer is obtained via an RS232 serial connection as is known in the art (standard connection utilized by most remote controls to access data and sensors). The type of information on the card can be personal information, such as who the person is, typically including the type of information that would be on an employee identification card. The card also carries information that authorizes the carrier to use the vehicle. This is accomplished through use of a personal identification number that is entered after the user engages the card by swiping or inserting the card into the reader. The computer activates a solenoid that allows the vehicle to start thereby giving an antitheft or unauthorized use capability to the device.

The card also contains information on it that communicates with a standard fuel dispensing station. It utilizes the data format that is found on any standard gas station credit card. The card is loaded with information on the correct amount of fuel, which is the amount of fuel that the vehicle has used since the last filling. Fuel theft by unauthorized persons and the unauthorized use of the employer's expensed account are thus prevented.

Telephone

An interface to a digital cellular phone allows the information obtained from the invention's data acquisition systems to be downloaded to a home computer. Information can be sent from the base personal computer to the working (main) computer via the same interface. The working computer is the invention computer discussed above; the home computer can be the base computer or PC or the business computer. This allows communication to optimize the use of the work vehicle. Information such as distance traveled, where the vehicle has traveled and who has the vehicle may be shared between computers. Preferably, this verbal and remote communication is obtained through a cellular telephone. A Nokia 6185i cellular telephone is the preferred currently available communication device, which contains an internal modem to connect to the invention computer. The interface to the digital cellular phone allows the information to be downloaded to a remote computer by methods known in the art.

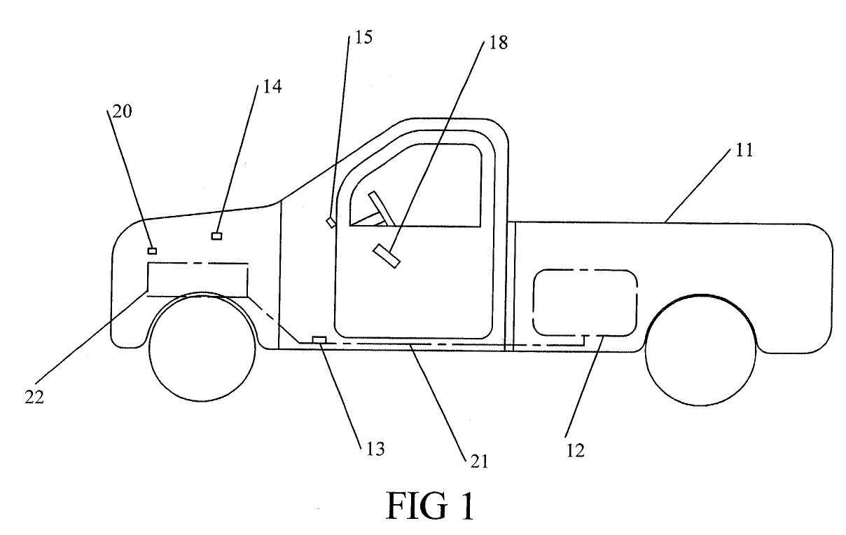

Referring in greater detail to the figures, a vehicle with the invention installed thereon is shown generally in the schematic diagram in FIG. 1, while the components of the systems of the invention and their interconnections are shown more specifically in FIGS. 2-5. These figures are discussed in more detail below.

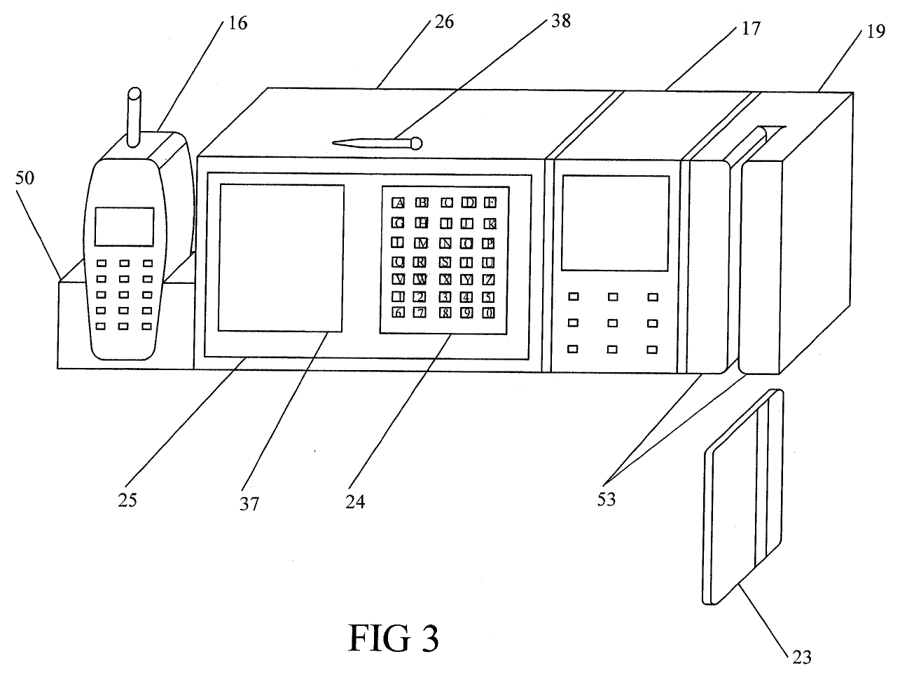

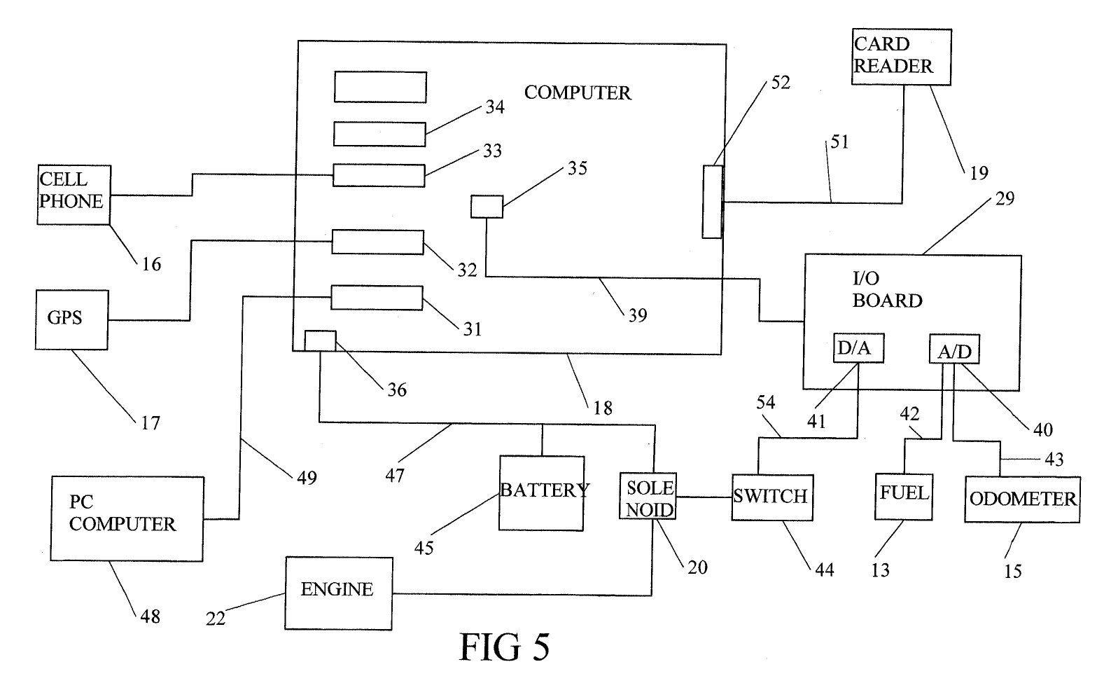

Main housing 26 of the computer 18, shown in FIG. 3, contains the computer 18, card reader 19 (magnetic strip reader), computer screen 25 and I/O expansion board module 29 (FIG. 5). Computer 18 is a typical embedded WINDOWS™ single board computer system, containing all the functions needed to support a WINDOWS™ operating system. As discussed above, computer 18 preferably has Visual Basic or Visual C++ system programming instructions and features. Computer 18 has internal memory of enough capability to hold several large programs and data that are generated from the operation of the device. The computer has a lithium battery for backup for short power disruptions. As shown in FIG. 5, connected to computer 18 are three communication ports, port 31, port 32, and port 33, plus printer port 34 and a RS485 serial port 35. These are standard features supplied by the manufacturer of the computer.

One useful screen 25 for computer 18 is a color graphics LCD touch screen, which preferably consists of a six-inch ¼ VGA (320×240) color graphics LCD display with touch screen, but other screens may be used. The sensitivity of the screen 25 is programmable to the individual tastes of the operator. It is activated by finger or the operator can use a plastic wand 38 to enter data into card reader 19 as is known in the art. Screen 25 is connected to computer 18 by the same printed circuit board that contains the computer processor as is known in the art. Screen 25 is divided into two sections, alphanumeric interface keyboard 24 and communication output 37. Keyboard 24 simulates the numbers and alphabet of a keyboard. Communication output 37 communicates questions or instructions on screen 25, such as querying as to the operator's name and identification number, instructions for the operator to swipe the card through the card reader for such things as security, and notification of the home office that the vehicle has been started legally or illegally, etc. Wand 38 is used to touch keyboard 24 in response to the questions or instructions from communication output 37.

I/O expansion board module 29 is connected to computer 18 through serial port 35 by cable 39 (FIG. 5). I/O expansion board module 29 contains an analog to digital converter 40 and a digital to analog converter 41. A/D converter 40 accepts signal voltage from fuel flow sensor 13 through cable 42. A/D converter 40 also is connected to odometer 15 by cable 43 through which a variable voltage is sent, the amount of which depends on the speed of the vehicle.

Digital to analog converter 41 is wired to DC solid-state relay switch 44 (FIG. 5). Further connected to relay switch 44 is ignition solenoid 20. Digital signal derived from computer 18 is converted to an analog voltage at digital to analog converter 41. The current output at digital to analog converter 41 is minimal and insufficient to activate solenoid 20 and therefore a relay switch is needed. Relay switch 44 connects power from the vehicle battery 45 to solenoid 20 when converter 41 generates more than 5 volts.

Power to computer 18 is obtained from vehicle 11 from battery 45 (FIG. 1). Computer 18 used in the invention has a built-in voltage regulator of 8 to 18 volts. The electrical system of vehicle 11 is standard twelve volts plus or minus two volts due to various components and conditions such as batteries, alternator and power used by ancillary equipment. Connection from battery 45 to computer 18 is made through power connection port 36 by power cable 47 (FIG. 5).

Software programming is developed on a remote personal computer 48 so that there is enough memory to hold the development software that generates the software used in the invention. Computer 48 also debugs the software prior to running, as is standard procedure for these types of computers. Temporary connection from computer 48 to computer 18 is made through cable 49 and connected at port 31 to download the program to the computer 18. Software is downloaded from computer 48 to computer 18 to change the software or a when a new program is needed. Printer port 34 is used by the business owner or his agent to print data from computer 18 in order to print any stored information. This would generally be the same information that the cell phone would transmit to the business office.

Connected to computer 18 through ports 32 and 33 are the GPS 17 and cellular telephone 16, respectively (FIG. 5). GPS 17 is mounted into housing 26 in the vehicle and on to computer 18. Telephone 16 is also connected to computer 18, and preferably is mounted on housing 50 as shown in FIG. 3.

Inside housing 26 next to GPS 17, magnetic card reader 19 is attached to computer 18 through cable 51 (FIG. 5). Cable 51 is connected to communication port 52 on computer 18. Credit card 23 is swiped between two parallel protrusions 53 (FIG. 3) jutting from the face of the main housing 26 as is known in the art. The card reader 19 is adapted to scan the data presented on the magnetic strip on the card 23.

Operation

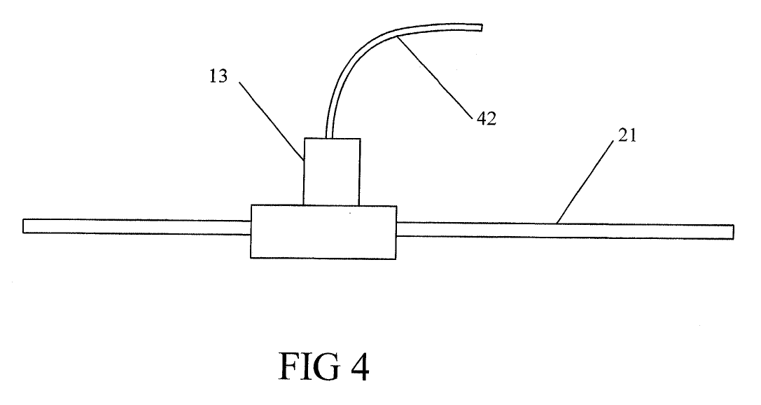

A typical embodiment of the operation of the present invention is illustrated in FIG. 1. Vehicle 11, which may be any car, truck van or any self-propelled vehicle of any size, has fuel flow sensor 13 installed in its system, either upon manufacture or retrofitted after purchase. Sensor 13 measures the amount of fuel by positive displacement. Sensor 13, as preferably utilized in the invention herein, is a small electromechanical device with multiple chambers that accepts a measured amount of fuel into each chamber. Each measured amount is electronically sensed and this unit of fuel is converted to a DC signal, which in turn is transmitted to computer 18. The fuel in the chamber is expelled as the next chamber is filled and the process is repeated. Sensor 13 is connected to vehicle battery 45 of 12 to 24 volts (FIG. 5). Vehicle battery 45 is generally the DC voltage source of the host vehicle. Each pulse of sensor 13 is a measured amount of fuel. Sensor 13 is installed in fuel line 21 at a point between fuel tank 12 and engine 22 where installation does not impede the operation of the engine 22 (FIGS. 1 and 4). Sensor 13 does not impede the flow of fuel to engine 22. Data is transmitted from sensor 13 to computer 18 via cable 42 (FIG. 5). Cable 42 is of a two wire configuration where the voltage output varies directly with the amount of fuel passing through the sensor 13, where information is analyzed and stored.

Input output expansion board module (I/O) 29 of computer 18 senses the voltage from sensor 13 and converts the voltage from a DC voltage to a digital signal by the use of analog to digital converter 40, which is part of the I/O expansion board module 29. The signal is converted from a 10 VDC to 12-bit digital utilizing a 12-bit A to D converter 40 sampling at up to 100 khz. The digitized signal then is transmitted to main bulk of computer 18 via cable 39.

Mileage is transmitted from digital vehicle odometer 15 of vehicle 11, digital odometers being standard in vehicles as manufactured, to computer 18. Digital vehicle odometer 15 develops a digital signal that is read via electrical 2-wire cable 43 back to computer 18 via A/D converter 40. The signal is recorded every time the odometer 15 registers 1/10 of a mile. These signals are summed in the computer 18.

Computer 18 has an output device that converts a digital signal to an analog signal. Connected to this digital to analog device 41 via 2-wire electrical cable 54 is a DC ignition solenoid 20. Solenoid 20 is connected either on the positive side or negative side of the main battery power supply and is placed in such a manner as to be inconspicuous to the operator. If the solenoid 20 is put in the positive side of the power supply then all the power is disconnected. If the negative side is employed the power is easily re-engaged by connecting the negative side of the battery to any place on the vehicle; conversely if using the positive side, the re-engaged connection would have to be across the discontinuity i.e. solenoid 20. Solenoid 20 receives a signal from the computer 18 via the D to A device 41 and closes to make contact thereby allowing the vehicle 11 to start.

The exact location of the vehicle 11 is tracked by GPS 17. Data collected by GPS 17 is used to produce the coordinates that are downloaded from GPS 17 directly into computer 18's internal bus via 64-pin connector. The information downloaded is the standard longitude and latitude location. Data is downloaded at frequent intervals, e.g., every one second, to insure mapping of the route the vehicle has taken. This gives a maximum distance between samples of 110 ft at 75 mph or 36 ft. at 25 mph. A data storage section is maintained in computer 18 that contains both the mileage from the signals from the GPS 17 and the odometer 15. Comparison of the two sets of data is assured by internal programming within the computer 18, which may be programmed using standard methods, and provides a failsafe method of verification of use of the vehicle.

Data collected and stored in the computer 18 is preferably uploaded by means known in the art to a main computer by the use of a cellular phone 16 connected to the computer 18. Cellular phone 16 can be activated by the vehicle operator or can be remotely called from the main office. The office can call the telephone number using the computer in the main office. The digital cell phone connects the two computers by means known in the art, for example, by using the same programming as is used to send email. The main computer records the information concerning the location, mileage, fuel used, and where the vehicle has been and time in each location. Adaptation of cellular phone 16 to computer 18 is through the I/O ports of computer 18.

To operate this invention, an operator inserts credit card 23 into the magnetic card reader 19. Credit card 23, comprising a magnetic strip with encoded sequence data is used to activate the invention and includes many features, such as the personal account information found on a standard credit card, a personal identification number to activate the card 23 and thereby allow starting the vehicle 11, and the necessary data to be downloaded to the fuel island pump. The information is read and passed via bus line cable 51 to the computer 18. The computer 18 activates the program and queries the operator for a personal identification number. The computer searches for a valid code or can be programmed to dial the main control office and request authorization through use of the cellular phone 16.

After successful verification, the computer 18 activates the shut-off solenoid 20. Upon activation of the solenoid 20, the vehicle 18 is ready to start. The operator starts the vehicle 11. After starting, the computer 18 updates its files, verifying location and miles traveled since last fueling. The computer 18 then writes data to the magnetic card strip 23, such as the time the vehicle was activated and the gallons of fuel needed.

The computer 18 asks the operator which operation needing to be done. Possible operations include transport from one location to another, performance of one or more of the various assigned tasks, or any other task not named here. A task such as performing a field maintenance assignment is an example of a task for which the invention is useful. Upon successful starting of the vehicle 11, the computer 18 is prompted by internal programming to ask the operator whether the operator needs to move the vehicle to the work site or other destinations, or perform an assigned task. The operator touches the screen 25 in the section assigned on the screen 25 for an answer, such as the desire to transport, and presses enter. Failure to answer and enter data appropriately activates the computer 18 to deactivate the starting solenoid 20. Deactivation disrupts electrical power to the engine 22, thereby stopping the engine 22. This feature reduces unauthorized use of the vehicle and requires the operator to enter data. The operator enters “transport” (meaning moving the vehicle to a different work site), and presses enter. The computer 18 queries the operator for the desired destination. The operator enters the location and begins his trip. The computer 18 records tenths of miles from both the odometer reading and the GPS data. Data computed include the total number of miles traveled and the route taken.

The computer 18 also monitors the velocity of the vehicle 11 to determine if the vehicle is stationary. If the vehicle 11 has been determined to be at a rest the computer 18 will prompt the operator for a status update. If the operator puts no data in such as would occur at stoplights and traffic congestion the computer 18 maintains the system as if in transport mode.

When the vehicle 11 is at rest, the computer 18 continually asks if the operator intends to perform another task. When performing a task, the operator must bring the vehicle 11 to a stop as a safety precaution before entering the information onto the screen 25. The computer 18 acts on this data bringing up programs that have been loaded into the computer 18's memory pertaining to the task. This feature helps verify the accuracy of the time the task took and what was required to complete the task. This feature is a very powerful management tool that the company can use to decrease the amount of wasted time between and during the tasks, increasing the productivity of the company as a whole.

All data is recorded and downloadable anytime through the cellular phone 16. The main office can download all data from vehicle 11, including transport information, and how long the task required. Incidental data can also be made available such as requirements for additional items to be ordered or used. The main office has instant access to billing and purchasing data.

When the vehicle 11 needs fuel as either determined by the driver or warned by the computer 18, the operator proceeds to the nearest refueling station. The prerequisite is that the fuel island must be equipped with the credit card pay-at-the-pump system.

The operator needing fuel must open up the program on the computer 18. The computer 18 ask if the vehicle 11 is to filled or use a lesser amount of fuel. The credit card 23 must be inserted in the card reader 19 if not already in place. The computer 18 downloads the amount of fuel that can be purchased onto the credit card 23. The computer 18 then signals the operator that the process is complete. The operator then removes the card 23 from the card writer and places the card 23 into the standard ‘pay at the pump’ fuel island.

The credit card 23 is coded exactly like a standard bank credit card or a standard fuel credit card. The fuel island contacts the credit-giving office and verifies the account as with a standard credit card. Once the card 23 has been accepted, the card 23 is asked for the amount of fuel needed. The fuel island treats the amount of fuel needed as a credit request. When the fuel amount is reached, the fuel island shuts off the pump and transmits this data back to the credit provider. The computer 18 resets its memory register to a full tank and begins its cycle over. The operator places the magnetic card 23 back into the card reader 19 of the computer 18. The computer 18 verifies the vehicle 11 was fueled through the screen 25 interfaces with the operator. The computer 18 then notifies the main office through the cellular phone 16 that the vehicle 11 has been filled. Data from the credit provider is compared to the data on the computer. Any discrepancies are noted and corrections are made to computer 18 and the company is notified.

As a further addition to the invention, a connection to the vehicle's engine computer 14 can be provided. The engine computer 14 can be accessed for information that the manufacturer of vehicle 11 has available. Depending upon the make and model, information, such as engine performance and standard maintenance requirements, can be downloaded into the computer and sent via cellular phone to the main office for disposition if needed. Maintenance records can be maintained to a high degree of certainty.

Information obtained as discussed above from the vehicle fuel flow sensor may first be used to calculate vehicle fuel usage, and further, this information on the amount of fuel used may be used to determine how much fuel an operator of the vehicle may purchase. In this case, the operator is only authorized to purchase essentially the same amount of fuel as has already been used (in other words, to refill the tank to where it was when the operator began). Such control is preferably exercised by instructions written to the magnetic card strip.

Instructions may also be written to the card that comprise a system for restricting vehicle use. This system for restricting vehicle use may, for example, comprises instructions from the computer causing the vehicle to cease operating at the end of a preselected time period, or causing the vehicle to cease operating when a preselected distance (determined as discussed above) has been traveled by the vehicle.

FIG. 6 shows an example of step-by-step use of the system of the invention. As shown, the operator initiates operation, and inserts a magnetic card (like a credit card) and enters the operator's PIN number. The system verifies that the operator is authorized and notifies the owner of the system that the vehicle is about to be used and by whom. This verification and authorization makes it possible for the operator to operate the vehicle. Vehicle information, including the odometer reading, the GPS reading and the fuel sensor information is noted in the system. The operator must then indicate his intention on using the system, generally with owner-customized software that is tailored to the types of tasks the owner wishes to have accomplished with the vehicle. When fuel is needed, the operator takes the steps discussed above with respect to the refueling step. The owner is notified of the purchase of fuel, and throughout use of the vehicle, data from the vehicle is sent via cellular phone to the computer as discussed in more detail above.

While the invention has been described with reference to specific embodiments, it will be appreciated that numerous variations, modifications, and embodiments are possible, and accordingly, all such variations, modifications, and embodiments are to be regarded as being within the spirit and scope of the invention. For example, the type of computer and its software can be different, the input to the computer can be accomplished with a typewriter-based keypad, the magnetic card input output can be modified to resemble something other than a credit card, and other variations within the spirit and scope of the invention may be employed.

What is claimed is:

1. A fuel and vehicle monitoring system for use with one or more vehicles of a business, comprising
a) a computer system;
b) a vehicle fuel flow sensor;
c) a system for monitoring for vehicle location and distance traveled by the vehicle;
d) a system for entering user information into the computer; and
e) a system for downloading information from the computer to a remote business site.

2. The fuel and vehicle monitoring system of claim 1, wherein the computer has a touch-screen for entering information or responding to queries on the computer.

3. The fuel and vehicle monitoring system of claim 1, wherein a global positioning system is used to monitor vehicle location and distance traveled.

4. The fuel and vehicle monitoring system of claim 1, wherein information about the distance traveled and fuel flow is used to calculate vehicle fuel usage.

5. The fuel and vehicle monitoring system of claim 1, further comprising a connection to an onboard computer system of the vehicle.

6. The fuel and vehicle monitoring system of claim 1, wherein the fuel flow sensor comprises a fuel flow meter.

7. The fuel and vehicle monitoring system of claim 1, wherein the distance traveled by a vehicle is monitored by a connection to an odometer of the vehicle.

8. The fuel and vehicle monitoring system of claim 1, wherein information obtained from the vehicle fuel flow sensor is used to calculate vehicle fuel usage, and wherein the amount of fuel used is used to determine how much fuel an operator of the vehicle may purchase.

9. The fuel and vehicle monitoring system of claim 1, further comprising a system for restricting vehicle use.

10. The fuel and vehicle monitoring system of claim 9, wherein the system for restricting vehicle use comprises instructions from said computer causing the vehicle to cease operating at the end of a preselected time period.

11. The fuel and vehicle monitoring system of claim 9, wherein the system for restricting vehicle use comprises instructions from said computer causing the vehicle to cease operating when a preselected distance has been traveled by the vehicle.

12. The fuel and vehicle monitoring system of claim 1, wherein the distance traveled by a vehicle is verified by comparison of readings obtained from an odometer on the vehicle and readings obtained by a global positioning system.

13. The fuel and vehicle monitoring system of claim 1, wherein the system for entering user information into the computer comprises a card reader/encoder attached to the computer and a card used by a user of the vehicle.

14. The fuel and vehicle monitoring system of claim 13, wherein the card contains information enabling communication with the remote business site.

15. The fuel and vehicle monitoring system of claim 1, further comprising a solenoid that is activated by the computer when the user is authorized to start the vehicle.

16. The fuel and vehicle monitoring system of claim 1, wherein the system for downloading information from the computer to a remote business site comprises an interface to a digital cellular telephone.

17. The fuel and vehicle monitoring system of claim 1, wherein:
a) a global positioning system is used to monitor vehicle location and distance traveled;
b) the fuel flow sensor comprises a fuel flow meter,
c) information about the distance traveled and fuel flow is used to calculate fuel usage of the one or more vehicles,
d) the system for entering user information into the computer comprises a card reader/encoder attached to the computer and a card used by the user, and the card contains information enabling communication with the remote business site, and
e) the system for downloading information from the computer to a remote business site comprises an interface to a digital cellular telephone.

18. A method of monitoring vehicle use, comprising providing a fuel and vehicle monitoring system according to claim 1.

19. A method of monitoring vehicle use, comprising providing a fuel and vehicle monitoring system according to claim 17.
